(19) United States
(12) Patent Application Publication
(10) Pub. No.: US 2022/0411667 A1
(43) Pub. Date: Dec. 29, 2022

(54) COMPOSITELY STRUCTURED INSULATION ADHESIVE FILM AND PREPARATION METHOD THEREOF

(71) Applicant: SHENZHEN INSTITUTES OF ADVANCED TECHNOLOGY CHINESE ACADEMY OF SCIENCES, Shenzhen (CN)

(72) Inventors: Suibin LUO, Shenzhen (CN); Pengpeng XU, Shenzhen (CN); Panpan RUAN, Shenzhen (CN); Shuhui YU, Shenzhen (CN); Tao ZHAO, Shenzhen (CN); Rong SUN, Shenzhen (CN)

(73) Assignee: SHENZHEN INSTITUTES OF ADVANCED TECHNOLOGY CHINESE ACADEMY OF SCIENCES, Shenzhen (CN)

(21) Appl. No.: 17/767,454

(22) PCT Filed: Oct. 10, 2019
(86) PCT No.: PCT/CN2019/110398

§ 371 Date: Apr. 8, 2022

(51) Int. Cl. C09J 7/30; B32B 27/36; B32B 27/32; B32B 27/08; B32B 7/06; B32B 37/24; B32B 37/06; C09J 7/25; C09J 11/04; C09J 163/00

(52) U.S. Cl. CPC C09J 7/30; B32B 27/36; B32B 27/32; B32B 27/08; B32B 7/06; B32B 37/24; B32B 37/06; C09J 7/25; C09J 11/04; C09J 163/00; B32B 2255/10; B32B 2255/26; B32B 2307/748; B32B 2307/732; B32B 2037/243; B32B 2309/02; B32B 2250/02; B32B 2250/24; B32B 2307/206; B32B 2255/28; B32B 2457/04; B32B 2405/00; B32B 2367/00; B32B 2323/10; C09J 2203/326; C09J 2301/312; C09J 2301/314

(57) ABSTRACT

The insulation adhesive film material is composed of a three-layer structure, its insulation polymer composite is supported by a thin film material, and a surface of the insulation polymer composite is covered with a layer of protective film. A release force of a support film is 25-60 μN/mm, and a release force of the protective film is 2-60 μN/mm. A thickness of the insulation polymer composite is 1-300 μm. The insulation adhesive film material is prepared as follows: after a high molecular polymer, an inorganic filler, a high molecular polymer curing agent, a molding auxiliary agent, and a solvent are mixed, dispersion technologies such as ball milling, sand milling, ultrasound are conducted to prepare an electronic paste of the insulation polymer composite, and the electronic paste is then applied to a surface of a support film material, and bonded with the protective film to form the insulation adhesive film material.

### CROSS REFERENCE TO THE RELATED APPLICATIONS

This application is the national phase entry of International Application No. PCT/CN2019/110398, filed on Oct. 10, 2019, the entire contents of which are incorporated herein by reference.

### TECHNICAL FIELD

The present disclosure belongs to the technical field of electronic packaging materials, and more particularly, the present disclosure relates to a compositely structured insulation adhesive film applied to semiconductor system in package.

### BACKGROUND

With the development of electronic information technology, especially the rapid development focused on wearable electronics, smart phones, ultra-thin computers, unmanned driving, Internet of Things technology and 5G communication technology in recent years, higher and higher requirements are put forward for miniaturization, thinning, multi-function, high performance and the like of electronic systems. As an important component of electronic information products, circuit boards require better performance and the smaller and thinner size.

Traditionally, circuit board machining adopts the subtraction preparation technology, that is, copper layers on the surfaces of copper clad laminate materials are subjected to technologies such as exposure, developing, etching and the like to prepare copper circuits, and then the circuit boards are obtained through multi-layer lamination. The circuit boards prepared by this solution have a great influence on the delay and attenuation of electrical signals due to the relatively large roughness of copper teeth of the copper layers. Meanwhile, the line width deviation of the circuits prepared by the etching technology is relatively large. In order to meet the application requirements of high-frequency and high-speed electronic information products, an additive process or a semi-additive process is adopted, that is, the copper circuits are prepared by chemical plating or electroplating on the surfaces of insulation materials, which can solve the above problems well.

In order to meet the technology of the additive process or the semi-additive process, new requirements are put forward for the structure of the insulation materials. Traditionally, the insulation materials are resin-impregnated glass fabric composite materials. Since the thickness of glass fabric is generally tens to hundreds of microns, the thickness of the resin-impregnated glass fabric composite materials is generally hundreds of microns. The cost of processing thinner glass fabric is increased very highly, which is not conducive to practical use. On such basis, the present disclosure provides a compositely structured material, which is more convenient to take, transfer and stick due to its three-layer structure design, and is suitable for the technology of the additive process or the semi-additive process.

### SUMMARY

In order to overcome the defects in the prior art, the present disclosure provides a compositely structured insulation adhesive film that can be used for semiconductor packaging and is suitable for preparation of fine circuits by an additive process or a semi-additive process.

In order to achieve the objectives of the above disclosure, the present disclosure adopts the following technical solutions.

A compositely structured insulation adhesive film is composed of a three-layer structure, wherein the compositely structured insulation adhesive film includes an insulation polymer composite layer, a thin film support layer at a bottom of the insulation polymer composite layer, and a protective film covering a surface of the insulation polymer composite layer; contact surfaces of the thin film support layer and the insulation polymer composite layer, and contact surfaces of the protective film and the insulation polymer composite layer are subjected to release treatment, a release force between the thin film support layer and the insulation polymer composite layer is 25 μN/mm to 60 μN/mm, and a release force between the contact surfaces of the protective film and the insulation polymer composite layer is 25 μN/mm to 60 μN/mm.

In a technical solution of the present disclosure, a material of the thin film support layer is selected from a polymer thin film material or a paper-based film material, the polymer thin film material is selected from a polyester thin film (PET), a polyether-ether-ketone thin film (PEEK), a polyetherimide thin film (PEI), a polyimide thin film (PI), and a polycarbonate thin film (PC), and the paper-based film material is selected from release paper and coated paper.

In a technical solution of the present disclosure, a thickness of the thin film support layer is 10 μm to 300 μm, preferably 20 μm to 100 μm, and more preferably 30 μm to 60 μm.

An insulation polymer composite electronic paste can form a uniform and smooth thin film on a surface of a support film material.

In a technical solution of the present disclosure, a material of the protective film is selected from a polymer thin film material, and the polymer thin film material is selected from a polyester thin film (PET), an oriented polypropylene thin film (OPP), and a polyethylene thin film (PE).

In a technical solution of the present disclosure, a thickness of the protective film is 10 μm to 300 μm, preferably 20 μm to 100 μm, and more preferably 30 μm to 60 μm.

In a technical solution of the present disclosure, a thickness of an insulation polymer composite between a support film and the protective film is 1 μm to 300 μm, preferably 10 μm to 150 μm.

In a case that the thickness is lower than 1 μm, holes are prone to occur, which is not conducive to reliability of products. In a case that the thickness is higher than 300 μm, problems such as solvent residue and bubble generation are prone to occur inside materials.

In a technical solution of the present disclosure, the contact surfaces of the thin film support layer and the insulation polymer composite layer, and the contact surfaces of the protective film and the insulation polymer composite layer are subjected to release treatment, and the release treatment is to treat the thin film support layer and the protective film by a release agent.

A release force of the thin film support layer is 25 μN/mm to 60 μN/mm. In a case that the release force of the thin film support layer is lower than 25 μN/mm, a coated insulation polymer composite is prone to a phenomenon of shrinkage cavities, and in a case that the release force of the thin film support layer is higher than 60 μN/mm, the insulation polymer composite is prone to phenomena such as cracking, hungry joint and the like in some positions when peeled off from the support film.

A release force of the protective film is 2 μN//mm to 60 μN/mm. In a case that the release force of the protective film is lower than 2 p.N//mm, a bonding force between the protective film and the insulation polymer composite is poor, and it is easy to leave a gap between the protective film and the insulation polymer composite, which are not conducive to storage of the materials. In a case that the release force of the protective film is higher than 60 μN/mm, part of the insulation polymer composite is easily adhered to the protective film when peeled off from the protective film, which affects thickness consistency of the polymer composite and reliability of the materials.

The release agent is selected from solvent-based organosilicon release agents such as LTC759, LTC 761, LTC 310, LTC 750A, SB7458, 7362, SB7588, SB7559, SB 7450, SB 9186, etc. produced by Dow Corning Corporation, solvent-free organosilicon release agents such as SL 200, SL160, SL 161, SL 210, SL 220, SL 240, SL 411, SL 9106, etc. produced by Dow Corning Corporation, emulsion-based organosilicon release agents such as 7920, 7935, 7934, etc. produced by Dow Corning Corporation, alkyl or polyethyleneimine high molecular polymers such as PEELOIL 1010, PEELOIL 1050, PEELOIL 1070, PEELOIL 406, etc. produced by Japan Lion Ipposha, and fluorine-containing block release agents such as MOLDSPATT MR W-823 produced by Japan Asahi Glass Corporation, and alkyd resin release agents such as SK-1, AL-5, AL-7, etc. produced by Lintec Corporation, preferably the solvent-free organosilicon release agents and the alkyd resin release agents. The desired release force may be obtained through commercially available release agents, which is a conventional means in the art.

A release agent treatment method is as follows: a coating mode such as smooth roll coating, mesh roll coating, scraper coating, curtain coating, etc., is adopted to cover a surface of a substrate with a release agent to obtain a release film.

Materials of both the thin film support layer and the protective film are selected from polymer thin films, which have the advantage that surface roughness of the thin films is extremely low, being beneficial to control thickness uniformity and surface roughness of the polymer composite in the middle.

A preparation method of the insulation adhesive film includes the following steps:

1) coating a thin film support layer and a protective film with a release agent respectively to reach a release force of 25 μN/mm to 60 μN/mm respectively;

2) coating the thin film support layer with an insulation polymer composite electronic paste, and conducting heating and drying to obtain an insulation polymer composite layer; and

3) covering the insulation polymer composite layer with the protective film for thermocompression treatment to obtain the insulation adhesive film with a three-layer structure,

wherein a temperature of thermocompression treatment in Step 3) is 60 to 90° C.;

wherein in Step 2), temperature-gradient heating and drying is conducted at a drying station, and a temperature rising interval is 60° C. to 120° C.; and

wherein the release force is preferably 25 μN/mm to 35 μN/mm.

The functions of the protective film mainly have two aspects: on the one hand, it is to reduce a thickness deviation of a thin film prepared from the polymer composite. After the polymer composite is coated with a film, certain thickness nonuniformity will be generally generated in a lateral direction. After a protective film material and the polymer composite are bonded at a certain temperature, a lateral thickness deviation may be reduced. On the other hand, after the protective film material and the polymer composite are bonded, the polymer composite may be prevented from being polluted by environmental dust, moisture and other factors.

The insulation polymer composite electronic paste is prepared from a high molecular polymer, an inorganic filler, a high molecular polymer curing agent, a molding auxiliary agent, a solvent and the like,

wherein the high molecular polymer is a thermosetting high molecule polymer, and the thermosetting high molecule polymer is selected from one or combination of two or more of epoxy resin, cyanate ester resin, bismaleimide resin, phenolic resin, amino resin, unsaturated polyester resin, and the like.

Based on the type of the high molecular polymer, corresponding curing agents and curing accelerators are selected. For example, if the epoxy resin is selected as a polymer matrix component for forming the insulation polymer composite electronic paste, it is necessary to add an amine curing agent such as dicyandiamine, bicyclic fluorene diamine, diaminodiphenyl sulfone, ethylenediamine, triethylene tetramine, 4,4-diaminodiphenylmethane, polyamide and the like, an anhydride curing agent such as methylnadic anhydride, tetrahydrophthalic anhydride, hexahydrophthalic anhydride, methyl tetrahydrophthalic anhydride, methyl hexahydrophthalic anhydride, dodecenyl succinic anhydride, N-dodecyl succinic anhydride, octenyl anhydride, phenylsuccinic anhydride, 2,3-naphthalic anhydride, and the like, and a curing accelerator such as 2-methylimidazole, 2-methyl-4-ethylimidazole, undecylimidazole, heptadecylimidazole, 2-phenylimidazole, 2-phenyl-4-methylimidazole, and 2,4,6-tris(dimethylaminomethyl)phenol.

The inorganic filler is one or a mixture of more of silica, alumina, boron nitride, barium titanate, titania, zinc oxide, zirconia, magnesia, calcium carbonate, and the like. A size of particles of the inorganic filler is 20 nm to 10 um, preferably 50 nm to 3 μm, and more preferably 200 nm to 1 μm, or the inorganic filler is a multi-scale mixture. Shapes of the particles of the inorganic filler are mainly spherical or quasi-spherical particles, and there may also be some particles with other shapes such as rods, lines, sheets, etc. The particles of the inorganic filler account for 20% to 80%, preferably 30% to 60%, and more preferably 45% to 55%, of a mass of a solid content, i.e., containing no volatile components such as solvents, of the composite.

The solvent is 2-butanone, toluene, propylene glycol methyl ether acetate, cyclohexanone, toluene cyclohexanone, chlorobenzene, dichlorobenzene, dichlorotoluene, ethyl ether, propylene oxide, methyl acetate, ethyl acetate, propyl acetate, methyl isobutyl ketone, ethylene glycol monomethyl ether, ethylene glycol monoethyl ether, ethylene glycol monobutyl ether, N,N-dimethylformamide, and acetone, wherein the solvent is preferably 2-butanone and propylene glycol methyl ether acetate.

A dispersing agent used in the present disclosure is one or combination of more of a nonionic emulsifier such as nonylphenol polyoxyethylene ether, alkylphenol polyoxyethylene ether, higher aliphatic alcohol polyoxyethylene ether, polyoxyethylene fatty acid, fatty acid methyl ester ethoxylate, a high molecular polymer and the like, an anionic emulsifier such as sodium cis-9-octadecenoate, sodium oleate, sodium stearate, sodium laurate, C13-C18 sodium alkyl benzene sulfonate, sulfate and the like, a cationic emulsifier, an alkyl ammonium salt such as dodecyl ammonium chloride, and quaternary ammonium salts such as cetyl trimethyl ammonium bromide, bromohexadecyl pyridine and the like.

The above high molecular polymer, inorganic filler, corresponding curing agent, solvent and related auxiliary agents such as a defoaming agent, a dispersing agent, a coupling agent, an anti-settling agent, a leveling agent, a rheological agent, a flame retardant and the like are mixed, and subjected to dispersing means such as stirring, ball milling, sand milling, ultrasound and the like to achieve uniform dispersion among respective components so as to form the insulation polymer composite electronic paste.

The preparation method of the insulation adhesive film is characterized in that the insulation polymer composite electronic paste is applied to a surface of the support film, and bonded with the protective film through drying in an oven to form the insulation adhesive film. A coating mode of the electronic paste may be intaglio printing, micro-intaglio printing, comma scraper, slit extrusion, etc. A solvent baking temperature is 50° C. to 50° C., and a bonding temperature is a room temperature to 150° C.

Any insulation adhesive film prepared according to the present disclosure can be applied to printed circuit boards (PCBs), substrates, carrier boards and the like. In a case of use, the protective film material on the insulation adhesive film is peeled off, and then an insulation polymer layer and a core board are bonded by thermocompression. After bonding, a certain temperature and time are maintained to make the insulation polymer reach a semi-cured state, and then a support film material is peeled off. After the support film material is peeled off, complete curing is conducted under certain temperature and time conditions, and then desired copper circuits are prepared on a surface of the insulation adhesive film by chemical plating or electroplating.

### BRIEF DESCRIPTION OF THE DRAWINGS

FIG. 1 is a schematic structural diagram of an insulation adhesive film, wherein 1-1 is a protective film, 1-2 is an insulation polymer composite, and 1-3 is a thin film support layer.

FIG. 2 is a schematic structural diagram of an insulation polymer composite in the insulation adhesive film, wherein 2-1 is inorganic filler particles, and 2-2 is a high molecular polymer.

FIG. 3 is a schematic flow diagram of preparing the insulation adhesive film of the present disclosure.

FIGS. 4A and 4B show the results of Embodiment 1.

FIG. 4A is a photo of coating a PET thin film with a release force of 20 μN/mm with an insulation polymer composite electronic paste prepared according to this formula. It can be seen that there will be a phenomenon of a large number of shrinkage cavities after paste coating.

FIG. 4B is a photo of coating a PET thin film with a release force of 25 μN/mm with the insulation polymer composite electronic paste prepared according to this formula. It can be seen that there is not a phenomenon of shrinkage cavities after paste coating.

FIGS. 5A-5C show the results of Embodiment 2.

FIG. 5A is a photo of coating a PET thin film with a release force of 15 μN/mm with an insulation polymer composite electronic paste prepared according to this formula. It can be seen that there will be a phenomenon of a large number of shrinkage cavities after paste coating.

FIG. 5B is a photo of coating a PET thin film with a release force of 20 μN/mm with the insulation polymer composite electronic paste prepared according to this formula. It can be seen that there is a phenomenon of shrinkage cavities at some positions after paste coating.

FIG. 5C is a photo of coating a PET thin film with a release force of 35 μN/mm with the insulation polymer composite electronic paste prepared according to this formula. It can be seen that there is not a phenomenon of shrinkage cavities after paste coating.

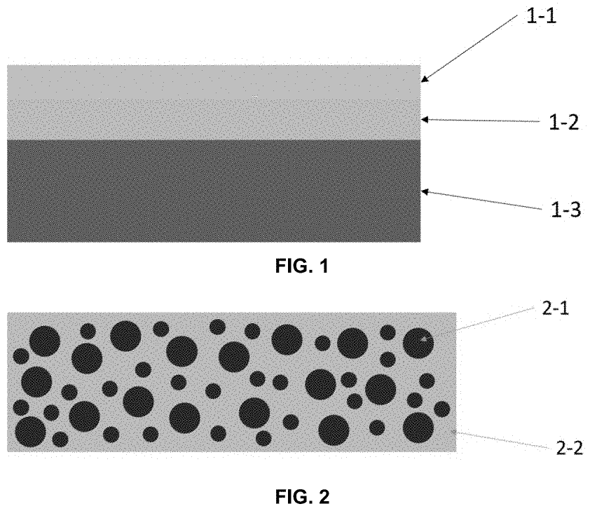

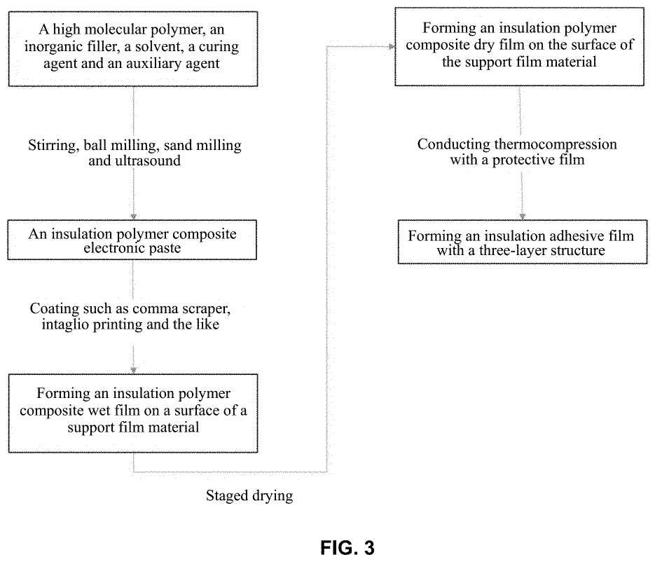

### DETAILED DESCRIPTION OF THE EMBODIMENTS

In order to make the above objectives, features and advantages of the present disclosure more obvious and easier to understand, the implementations of the present disclosure are described in detail below in combination with the accompanying drawings, but this shall not be construed as limiting the implementable scope of the present disclosure.

The present embodiment provides an insulation adhesive film that is suitable for semiconductor packaging and suitable for preparation of fine circuits by an additive process or a semi-additive process, wherein the insulation adhesive film is prepared through the following steps.

Embodiment 1. Preparation of Insulation Adhesive Film

1) The following components are weighed and then mixed:

Spherical silica 10 g

Epoxy resin NPPN-6385 10 g

Epoxy resin E 51 3 g

Dicyandiamine 0.65 g

2-Methyl-4-ethylimidazole 0.01 g

Nonylphenol polyoxyethylene ether 0.3 g

N,N-dimethylformamide 10 g

Butanone 10 g

An insulation polymer composite electronic paste is obtained after ball milling at 600 rpm for 12 hours.

2) A PET thin film is coated with a release agent, and a release force is determined by adjusting an addition amount and testing a state after coating.

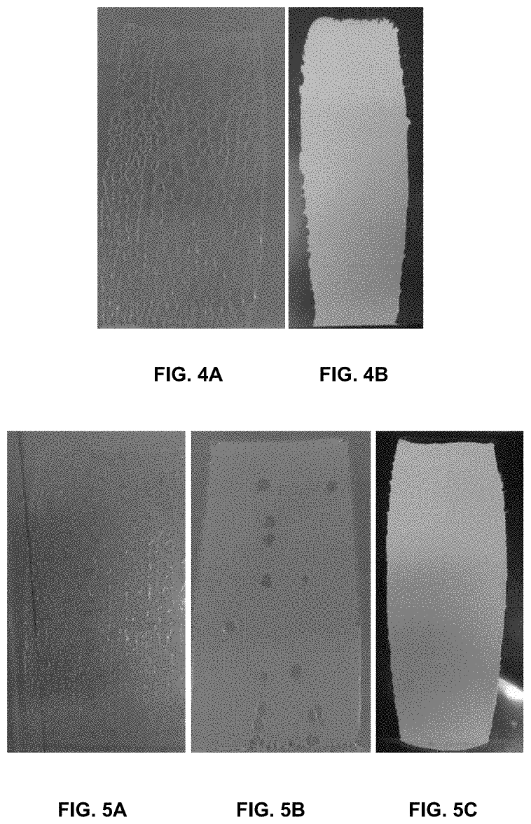

3) Surfaces of 50 μm thickness PET thin films with different release forces are coated with the insulation polymer composite electronic paste by using a comma scraper coating mode, states are observed, and results are shown in FIG. 4 and Table 1.

4) A thickness of an insulation polymer composite thin film is controlled according to a solid content of the electronic paste and a distance between a scraper and the PET thin film. A thickness of the thin film after drying is controlled to be 25 μm. A staged oven is used in a drying process. A temperature of the oven adopts staged temperature rising, and starting from a coating end, the temperature of the oven is set to 60° C., 80° C., 100° C., 110° C. and 120° C.

5) The dried insulation polymer composite thin film and an OPP thin film with a thickness of 25 μm are composited by thermocompression. In a process of thermocompression, a temperature of a heating roll is set to 70° C. After thermocompression, the insulation adhesive film with a three-layer structure is obtained.

FIG. 4A is a photo of coating a PET thin film with a release force of 20 μN/mm with an insulation polymer composite electronic paste prepared according to this formula. It can be seen that there will be a phenomenon of a large number of shrinkage cavities after paste coating.

FIG. 4B is a photo of coating a PET thin film with a release force of 25 μN/mm with the insulation polymer composite electronic paste prepared according to this formula. It can be seen that there is not a phenomenon of shrinkage cavities after paste coating.

The release agent is a solvent-free organosilicon release agent SL-200.

The adopted PET and OPP release films are prepared by smooth roll coating.

In the present disclosure, a release force test method is as follows: (1) taking TESA 7475 tape with a width of 25.4 mm and a length of 200 mm to be stuck on a testing surface (a release surface) of a film, and rolling the tape 3 times back and forth with a 2 KG standard rolling hand roll, wherein it shall be rolling while full sticking to avoid bubbles between the tape and the release film when the tape is stuck; (2) after the tape is stuck, conducting still standing for 20 minutes, wherein a temperature and a humidity of a laboratory are controlled at 23±2° C. and 50±5% respectively; (3) sticking double-sided tape on a non-testing surface of a sample, and fixing the sample to a standard steel plate to be tested; (4) installing a material on a fixture, and conducting testing in a method of pulling the tested tape at an angle of 180 degrees by a tensile machine, wherein data displayed by a computer of the tensile machine are release forces of the tested sample, and an average value of 5 numerical values is taken as a test result.

By testing peeling of the PET thin film, it can be seen that peeling may be easy under a release force between 25 to 30 _{I}tN/mm in a case of need without damaging a conductive paste layer.

Embodiment 2. Preparation of Insulation Adhesive Film

1) The following components are weighed and then mixed:

Spherical alumina 10 g

Epoxy resin HyPox RK 84 5 g

Epoxy resin NPPN-431A70 8g

Dicyandiamine 0.4 g

2-Methyl-4-ethylimidazole 0.01 g

Nonylphenol polyoxyethylene ether 0.3 g

N,N-dimethylformamide 10 g

Butanone 10 g

An insulation polymer composite electronic paste is obtained after ball milling at 600 rpm for 12 hours.

2) A PET thin film is coated with a release agent, and a release force is determined by adjusting an addition amount and testing a state after coating.

3) Surfaces of 50 μm thickness PET thin films with different release forces are coated with the insulation polymer composite electronic paste by using a comma scraper coating mode, and results are shown in FIGS. 5A-5C and Table 1.

4) A thickness of an insulation polymer composite thin film is controlled according to a solid content of the electronic paste and a distance between a scraper and the PET thin film. A thickness of the thin film after drying is controlled to be 20 μm. A staged oven is used in a drying process. A temperature of the oven adopts staged temperature rising, and starting from a coating end, the temperature of the oven is set to 60° C., 80° C., 100° C., 110° C. and 120° C.

5) The dried insulation polymer composite thin film and an OPP thin film with a thickness of 25 μm are composited by thermocompression. In a process of thermocompression, a temperature of a heating roll is set to 70° C. After thermocompression, the insulation adhesive film with a three-layer structure is obtained.

FIG. 5A is a photo of coating a PET thin film with a release force of 15 μN/mm with an insulation polymer composite electronic paste prepared according to this formula. It can be seen that there will be a phenomenon of a large number of shrinkage cavities after paste coating.

FIG. 5B is a photo of coating a PET thin film with a release force of 20 μN/mm with the insulation polymer composite electronic paste prepared according to this formula. It can be seen that there is a phenomenon of shrinkage cavities at some positions after paste coating.

FIG. 5C is a photo of coating a PET thin film with a release force of 35 μN/mm with the insulation polymer composite electronic paste prepared according to this formula. It can be seen that there is not a phenomenon of shrinkage cavities after paste coating.

By testing peeling of the PET thin film, it can be seen that peeling may be easy under a release force between 25 to 30 _{I}tN/mm in a case of need without damaging a conductive paste layer.

TABLE 1
Test Results of Release Forces in Embodiments 1 and 2

| Release agent | Release forces (μN/mm) | | | |
|---|---|---|---|---|
| (AL-200) | 15 μN/mm | 20 μN/mm | 25 μN/mm | 35 μN/mm |
| Embodiment 1 | x | x | ∘ | ∘ |
| Embodiment 2 | x | x | ∘ | ∘ |

Note:
x indicates that there is a phenomenon of shrinkage cavities after coating, and ∘ indicates a smooth surface after coating.

What we claimed is:

1. A compositely structured insulation adhesive film, comprising a three-layer structure, wherein the three-layer structure comprises an insulation polymer composite layer, a thin film support layer at a bottom of the insulation polymer composite layer, and a protective film covering a surface of the insulation polymer composite layer;
wherein contact surfaces of the thin film support layer and the insulation polymer composite layer, and contact surfaces of the protective film and the insulation polymer composite layer are subjected to release treatment,
a release force between the thin film support layer and the insulation polymer composite layer is 25 μN/mm to 60 μN/mm, and
a release force between the contact surfaces of the protective film and the insulation polymer composite layer is 25 μN/mm to 60 μN/mm.

2. The compositely structured insulation adhesive film Rofflaccording to claim 1, wherein a material of the thin film support layer is a polymer thin film material or a paper-based film material.

3. The compositely structured insulation adhesive film according to claim 2, wherein
the polymer thin film material is selected from the group consisting of a polyester thin film (PET), a polyether-ether-ketone thin film (PEEK), a polyetherimide thin film (PEI), a polyimide thin film (PI), and a polycarbonate thin film (PC), and
the paper-based film material is selected from the group consisting of release paper and coated paper.

4. The compositely structured insulation adhesive film according to claim 1, wherein a thickness of the thin film support layer is 10 μm to 300 μm.

5. The compositely structured insulation adhesive film according to claim 1, wherein a thickness of the thin film support layer is 20 μm to 100 μm.

6. The compositely structured insulation adhesive film according to claim 1, wherein a thickness of the thin film support layer is 30 μm to 60 μm.

7. The compositely structured insulation adhesive film according to claim 1, wherein a material of the protective film is a polymer thin film material.

8. The compositely structured insulation adhesive film according to claim 7, wherein the polymer thin film material is selected from the group consisting of a polyester thin film (PET), an oriented polypropylene thin film (OPP), and a polyethylene thin film (PE).

9. The compositely structured insulation adhesive film according to claim 1, wherein a thickness of the protective film is 10 μm to 300 μm.

10. The compositely structured insulation adhesive film according to claim 9, wherein the thickness of the protective film is 20 μm to 100 μm.

11. The compositely structured insulation adhesive film according to claim 9, wherein the thickness of the protective film is 30 μm to 60 μm.

12. The compositely structured insulation adhesive film according to claim 1, wherein a thickness of an insulation polymer composite between the thin film support layer support film and the protective film is 1 μm to 300 μm.

13. The compositely structured insulation adhesive film according to claim 12, wherein the thickness of the insulation polymer composite between the thin film support film and the protective film is 10 μm to 150 μm.

14. The compositely structured insulation adhesive film according to claim 1 wherein the release treatment comprises treating the thin film support layer and the protective film by a release agent.

15. The compositely structured insulation adhesive film according to claim 1, wherein
the insulation polymer composite layer is obtained by coating the thin film support layer with an insulation polymer composite electronic paste and then conducting drying, and
the insulation polymer composite electronic paste is prepared from raw materials comprising a high molecular polymer, an inorganic filler, a high molecular polymer curing agent, a solvent and an auxiliary agent.

16. The compositely structured insulation adhesive film according to claim 15, wherein the high molecular polymer is selected from a thermosetting high molecule polymer, and the thermosetting high molecule polymer is at least one selected from the group consisting of epoxy resin, cyanate ester resin, bismaleimide resin, phenolic resin, amino resin, and unsaturated polyester resin.

17. The compositely structured insulation adhesive film according to claim 15, wherein the high molecular polymer curing agent is an amine curing agent or an anhydride curing agent,
wherein the amine curing agent is selected from the group consisting of dicyandiamine, bicyclic fluorene diamine, diaminodiphenyl sulfone, ethylenediamine, triethylene tetramine, 4,4-diaminodiphenylmethane, and polyamide,
wherein the anhydride curing agent is selected from the group consisting of methylnadic anhydride, tetrahydrophthalic anhydride, hexahydrophthalic anhydride, methyl tetrahydrophthalic anhydride, methyl hexahydrophthalic anhydride, dodecenyl succinic anhydride, N-dodecyl succinic anhydride, octenyl anhydride, phenylsuccinic anhydride, 2,3-naphthalic anhydride, and a curing accelerator,
wherein the curing accelerator is selected from the group consisting of 2-methylimidazole, 2-methyl-4-ethylimidazole, undecylimidazole, heptadecylimidazole, 2-phenylimidazole, 2-phenyl-4-methylimidazole, and 2,4,6-tris(dimethylaminomethyl)phenol.

18. The compositely structured insulation adhesive film according to claim 15, wherein the inorganic filler is at least one selected from the group consisting of silica, alumina, boron nitride, barium titanate, zinc oxide, zirconia, magnesia, and calcium carbonate.

19. The compositely structured insulation adhesive film according to claim 21, wherein the dispersing agent is selected from the group consisting of a nonionic emulsifier, an anionic emulsifier, an alkyl ammonium salt emulsifier, and a cationic emulsifier,
wherein the nonionic emulsifier is selected from the group consisting of nonylphenol polyoxyethylene ether, alkylphenol polyoxyethylene ether, higher aliphatic alcohol polyoxyethylene ether, polyoxyethylene fatty acid, fatty acid methyl ester ethoxylate, and a high molecular polymer,
wherein the anionic emulsifier is selected from the group consisting of sodium cis-9-octadecenoate, sodium oleate, sodium stearate, sodium laurate, C13-C18 sodium alkyl benzene sulfonate, and sulfate,
wherein the alkyl ammonium salt is selected from the group consisting of dodecyl ammonium chloride, cetyl trimethyl ammonium bromide, and bromohexadecyl pyridine.

20. The compositely structured insulation adhesive film according to claim 15, the solvent is selected from the group consisting of 2-butanone, toluene, propylene glycol methyl ether acetate, cyclohexanone, methylcyclohexanone, chlorobenzene, dichlorobenzene, dichlorotoluene, ethyl ether, propylene oxide, methyl acetate, ethyl acetate, propyl acetate, methyl isobutyl ketone, ethylene glycol monomethyl ether, ethylene glycol monoethyl ether, ethylene glycol monobutyl ether, N,N-dimethylformamide, and acetone.

21. The compositely structured insulation adhesive film according to claim 15, the auxiliary agent is at least one agent selected from the group consisting of a defoaming agent, a dispersing agent, a coupling agent, an anti-settling agent, a leveling agent, a rheological agent, and a flame retardant.

22. The compositely structured insulation adhesive film according to claim 15, wherein the insulation polymer composite electronic paste is prepared by mixing and uniformly dispersing the raw materials to form the insulation polymer composite electronic paste.

23. A preparation method of the compositely structured insulation adhesive film according to claim 1, comprising the following steps:
1) coating the thin film support layer and the protective film with a release agent respectively to reach the release force of 25 μN/mm to 60 μN/mm respectively;
2. coating the thin film support layer with an insulation polymer composite electronic paste, and conducting temperature-gradient heating and drying to obtain the insulation polymer composite layer; and
3. covering the insulation polymer composite layer with the protective film for a thermocompression treatment to obtain the compositely structured insulation adhesive film with the three-layer structure,
wherein a temperature of the thermocompression treatment in step 3 is 60 to 90° C.; and
wherein in step 2, the temperature-gradient heating and the drying are conducted at a drying station, and a temperature rising interval is 60° C. to 120° C.

24. The preparation method according to claim 23, wherein the release force in step 1 is 25 μN/mm to 35 μN/mm.
